(19) United States
(12) Patent Application Publication
(10) Pub. No.: US 2018/0241572 A1
(43) Pub. Date: Aug. 23, 2018

(54) TECHNIQUES FOR REMOTE SGX ENCLAVE AUTHENTICATION

(71) Applicant: INTEL CORPORATION, SANTA CLARA, CA (US)

(72) Inventors: ANDREA MIELE, HILLSBORO, OR (US); KARLA SAUR, PORTLAND, OR (US); JAMES HELD, PORTLAND, OR (US); MIC BOWMAN, BEAVERTON, OR (US)

(73) Assignee: INTEL CORPORATION, SANTA CLARA, CA (US)

(21) Appl. No.: 15/600,667

(22) Filed: May 19, 2017

Related U.S. Application Data
(60) Provisional application No. 62/462,298, filed on Feb. 22, 2017.

(51) Int. Cl. H04L 9/32; H04L 9/06; H04W 12/06

(52) U.S. Cl. CPC H04L 9/3263; H04L 9/0643; H04W 12/06; H04L 2201/08; H04L 2209/42; H04L 2209/24; H04L 2209/08; H04L 2209/34

(57) ABSTRACT

Techniques for remote SGX enclave authentication are described. An attestation service may be used to attest that an enclave was successfully established on a Software Guard Extensions (SGX) enabled platform. Further, an attestation service may, in embodiments, be used as a notary system to attest that a public-key certificate was generated by a particular SGX enclave and, therefore, may be trusted by other remote enclaves for authentication. In an embodiment, a client-side SGX enclave may generate a public-private key pair (SK, PK), compute a cryptographic hash H of PK, create a report R containing H, obtain a quote Q on the report R from a quoting enclave component, obtain remote attestation response RA from an attestation service, and broadcast RA and PK to one or more server side SGX enclaves. Other embodiments are described and claimed.

### RELATED APPLICATIONS

This application claims the benefit of priority under 35 U.S.C. § 119(e) to U.S. Provisional Application No. 62/462,298, entitled “TECHNIQUES FOR REMOTE SGX ENCLAVE AUTHENTICATION” filed Feb. 22, 2017, which is hereby incorporated by reference in its entirety.

### FIELD OF THE DISCLOSURE

The disclosure generally relates to techniques for authentication within distributed computing environments.

### BACKGROUND

In some devices utilizing trusted execution environments, sensitive portions of an application may be executed and/or stored in a secure environment, called an enclave, to protect both code and data from compromise. In distributed applications, such as Internet of Things (IoT) systems, in one example, enclaves residing on different processors may be required to mutually authenticate to establish secure communication channels. Many current solutions rely upon a centralized trusted authority to authenticate two remote enclaves within a distributed system. The use of a centralized trusted authority, in some cases, may expose the identity of one or more parties, which may not be desired by those favoring anonymity. Thus, improved techniques that may not require a centralized trusted authority to perform authentication between enclaves within a distributed system are desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Techniques for remote enclave authentication are described. An attestation service, such as the Intel Attestation Service (IAS) may be used to attest that an enclave was successfully established on a Software Guard Extensions (SGX) enabled platform. Further, an IAS may, in embodiments, be used as a notary system to attest that a public-key certificate was generated by a particular SGX enclave and, therefore, may be trusted by other remote enclaves for authentication. In an embodiment, a client-side SGX enclave may generate a public-private key pair (SK, PK), compute a cryptographic hash H of PK, create a report R containing H, obtain a quote Q on the report R from a quoting enclave component, obtain remote attestation response RA from an attestation service, and broadcast RA and PK to one or more server side SGX enclaves. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of an operating environment.

FIG. 2 illustrates an embodiment of a trusted enclave system.

FIG. 3 illustrates an architecture of a trusted enclave system.

FIG. 4 illustrates an embodiment of a system.

FIG. 5 illustrates a logic flow according to an embodiment.

FIG. 6A illustrates a logic flow according to an embodiment.

FIG. 6B illustrates a logic flow according to an embodiment.

FIG. 7 illustrates an article of manufacture according to an embodiment.

FIG. 8 illustrates an embodiment of a centralized system.

FIG. 9 illustrates an embodiment of a distributed system.

FIG. 10 illustrates an embodiment of a computing architecture.

FIG. 11 illustrates an embodiment of a communications architecture.

### DETAILED DESCRIPTION

Techniques for remote SGX enclave authentication are described. An attestation service, such as the Intel Attestation Service (IAS) may be used to attest that an enclave was successfully established on a Software Guard Extensions (SGX) enabled platform. Further, an IAS may, in embodiments, be used as a notary system to attest that a public-key certificate was generated by a particular SGX enclave and, therefore, may be trusted by other remote enclaves for authentication. Other embodiments are described and claimed.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

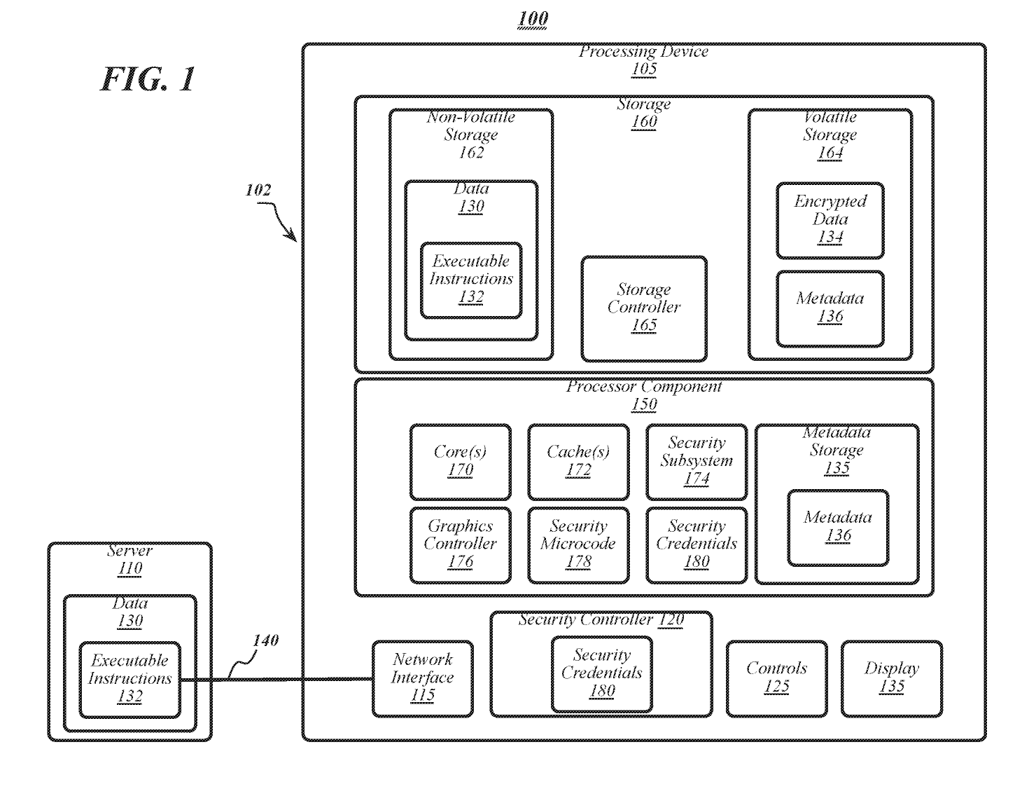

FIG. 1 illustrates an example of an operating environment 100 such as may be representative of some embodiments. In operating environment 100, which may include remote enclave authentication, a system 102 may include a server 110 and a processing device 105 coupled via a network 140. Server 110 and processing device 105 may exchange data 130 via network 140, and data 130 may include executable instructions 132 for execution within processing device 105. In some embodiments, data 130 may be include data values, executable instructions, and/or a combination thereof. Network 140 may be based on any of a variety (or combination) of communications technologies by which signals may be exchanged, including without limitation, wired technologies employing electrically and/or optically conductive cabling, and wireless technologies employing infrared, radio frequency, and/or other forms of wireless transmission.

In various embodiments, processing device 105 may incorporate a processor component 150, a storage 160, controls 125 (for instance, manually-operable controls), a display 135 and/or a network interface 115 to couple processing device 105 to network 140. Processor component 150 may incorporate security credentials 180, a security microcode 178, metadata storage 135 storing metadata 136, a security subsystem 174, one or more processor cores 170, one or more caches 172 and/or a graphics controller 176. Storage 160 may include volatile storage 164, non-volatile storage 162, and/or one or more storage controllers 165. Processing device 105 may include a controller 120 (for example, a security controller) that may include security credentials 180. Controller 120 may also include one or more of the embodiments described herein for unified hardware acceleration of hash functions.

Volatile storage 164 may include one or more storage devices that are volatile in as much as they require the continuous provision of electric power to retain information stored therein. Operation of the storage device(s) of volatile storage 164 may be controlled by storage controller 165, which may receive commands from processor component 150 and/or other components of processing device 105 to store and/or retrieve information therein, and may convert those commands between the bus protocols and/or timings by which they are received and other bus protocols and/or timings by which the storage device(s) of volatile storage 164 are coupled to the storage controller 165. By way of example, the one or more storage devices of volatile storage 164 may be made up of dynamic random access memory (DRAM) devices coupled to storage controller 165 via an interface, for instance, in which row and column addresses, along with byte enable signals, are employed to select storage locations, while the commands received by storage controller 165 may be conveyed thereto along one or more pairs of digital serial transmission lines.

Non-volatile storage 162 may be made up of one or more storage devices that are non-volatile inasmuch as they are able to retain information stored therein without the continuous provision of electric power. Operation of storage device(s) of non-volatile storage 162 may be controlled by storage controller 165 (for example, a different storage controller than used to operate volatile storage 164), which may receive commands from processor component 150 and/or other components of processing device 105 to store and/or retrieve information therein, and may convert those commands between the bus protocols and/or timings by which they are received and other bus protocols and/or timings by which the storage device(s) of non-volatile storage 162 are coupled to storage controller 165. By way of example, one or more storage devices of non-volatile storage 162 may be made up of ferromagnetic disk-based drives (hard drives) operably coupled to storage controller 165 via a digital serial interface, for instance, in which portions of the storage space within each such storage device are addressed by reference to tracks and sectors. In contrast, commands received by storage controller 165 may be conveyed thereto along one or more pairs of digital serial transmission lines conveying read and write commands in which those same portions of the storage space within each such storage device are addressed in an entirely different manner.

Processor component 150 may include at least one processor core 170 to execute instructions of an executable routine in at least one thread of execution. However, processor component 150 may incorporate more than one of processor cores 170 and/or may employ other processing architecture techniques to support multiple threads of execution by which the instructions of more than one executable routine may be executed in parallel. Cache(s) 172 may include a multilayer set of caches that may include separate first level (L1) caches for each processor core 170 and/or a larger second level (L2) cache for multiple ones of processor cores 170.

In some embodiments in which processing device 105 includes display 135 and/or graphics controller 176, one or more cores 170 may, as a result of executing the executable instructions of one or more routines, operate controls 125 and/or the display 135 to provide a user interface and/or to perform other graphics-related functions. Graphics controller 176 may include a graphics processor core (for instance, a graphics processing unit (GPU)) and/or component (not shown) to perform graphics-related operations, including and not limited to, decompressing and presenting a motion video, rendering a 2D image of one or more objects of a three-dimensional (3D) model, etc.

Non-volatile storage 162 may store data 130, including executable instructions 132. In the aforementioned exchanges of data 130 between processing device 105 and server 110, processing device 105 may maintain a copy of data 130, for instance, for longer term storage within non-volatile storage 162. Volatile storage 164 may store encrypted data 134 and/or metadata 136. Encrypted data 134 may be made up of at least a portion of data 130 stored within volatile storage 164 in encrypted and/or compressed form according to some embodiments described herein. Executable instructions 132 may make up one or more executable routines such as an operating system (OS), device drivers and/or one or more application routines to be executed by one or more processor cores 170 of processor component 150. Other portions of data 130 may include data values that are employed by one or more processor cores 170 as inputs to performing various tasks that one or more processor cores 170 are caused to perform by execution of executable instructions 132.

As part of performing executable instructions 132, one or more processor cores 170 may retrieve portions of executable instructions 132 and store those portions within volatile storage 164 in a more readily executable form in which addresses are derived, indirect references are resolved and/or links are more fully defined among those portions in the process often referred to as loading. As familiar to those skilled in the art, such loading may occur under the control of a loading routine and/or a page management routine of an OS that may be among executable instructions 132. As portions of data 130 (including portions of executable instructions 132) are so exchanged between non-volatile storage 162 and volatile storage 164, security subsystem 174 may convert those portions of data 130 between what may be their original uncompressed and unencrypted form as stored within non-volatile storage 162, and a form that is at least encrypted and that may be stored within volatile storage 164 as encrypted data 134 accompanied by metadata 136.

Security subsystem 174 may include hardware logic configured or otherwise controlled by security microcode 178 to implement the logic to perform such conversions during normal operation of processing device 105. Security microcode 178 may include indications of connections to be made between logic circuits within the security subsystem 174 to form such logic. Alternatively or additionally, security microcode 178 may include executable instructions that form such logic when so executed. Either security subsystem 174 may execute such instructions of the security microcode 178, or security subsystem 174 may be controlled by at least one processor core 170 that executes such instructions. Security subsystem 174 and/or at least one processor core 170 may be provided with access to security microcode 178 during initialization of the processing device 105, including initialization of the processor component 150. Further, security subsystem 174 may include one or more of the embodiments described herein for unified hardware acceleration of hash functions.

Security credentials 180 may include one or more values employed by security subsystem 174 as inputs to its performance of encryption of data 130 and/or of decryption of encrypted data 134 as part of performing conversions there between during normal operation of processing device 105. More specifically, security credentials 180 may include any of a variety of types of security credentials, including and not limited to public and/or private keys, seeds for generating random numbers, instructions to generate random numbers, certificates, signatures, ciphers, and/or the like. Security subsystem 174 may be provided with access to security credentials 180 during initialization of the processing device 105.

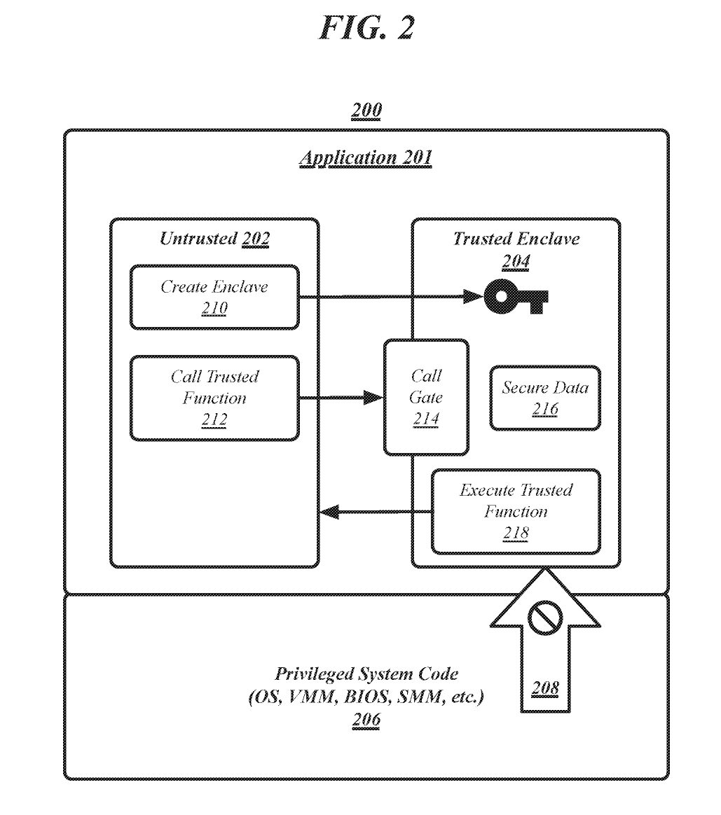

FIG. 2 illustrates an embodiment of a trusted enclave system 200. Trusted enclave system 200 may include application 201, which may include one or more applications executing on a software and/or hardware platform. A few non-limiting examples of applications that may include secret data in need of protection are financial applications, electronic banking applications, and health or medical applications. In some embodiments, application 201 may include an untrusted partition 202, which may be a partition of application 201 that includes instructions and data that are generally unprotected from an attack. Privileged code 206 may include code of a platform that has special access, or privilege, to data within applications running on the platform. Privileged code may include the operating system, a virtual machine manager, system BIOS, or system management mode, for example. While these exemplary types of privileged code may be used here, it can be appreciated that other types of code may permanently or temporarily include privilege.

If malicious code were to infect privileged system code 206, it may have access to untrusted partition 202, since privileged system code 206 generally has access to application 201. Using a trusted enclave system, however, certain data may be kept secret and secure, even from an attack originating from privileged system code 206. In an example, application 201 may create a trusted enclave 204 at 210 to protect secret data and secure data 216. The creation of a trusted enclave 204 may generate a secure memory location, sometimes within a processor of a platform, accessible using the techniques described herein. Trusted enclave 204 may be configured to support certain trusted functions that may execute on secure data 216. Untrusted partition 202 may call a trusted function at 212 using a call gate 214, which may be a combination of software and hardware configured to accept certain trusted function calls at trusted enclave 204. The resulted of a trusted function call may be returned from trusted enclave 204 to untrusted partition 202, while secure data 216 remains protected within trusted enclave 204. In this manner, secure data 216 may be accessed using a limited set of trusted functions, secure data 216 may still be used within application 201, however, as shown by blockage 208, privileged system code 208 may be prevented from accessing secure data 216.

Trusted enclave system 200 allows for each application running on a platform to defend its own secret data using secure enclaves, significantly reducing the attack surface available to malicious code, especially malicious code that has infiltrated privileged system code 206. While the embodiment described within FIG. 2 illustrates a single platform, trusted enclave systems may be used within networked distributed systems, such as IoT. In these systems, as described later, a centralized trusted authority may be used to authenticate secure enclaves. However, as described below, improved techniques may circumvent the use of a centralized trusted authority and allow trusted enclaves running of multiple distributed processors to authenticate one another.

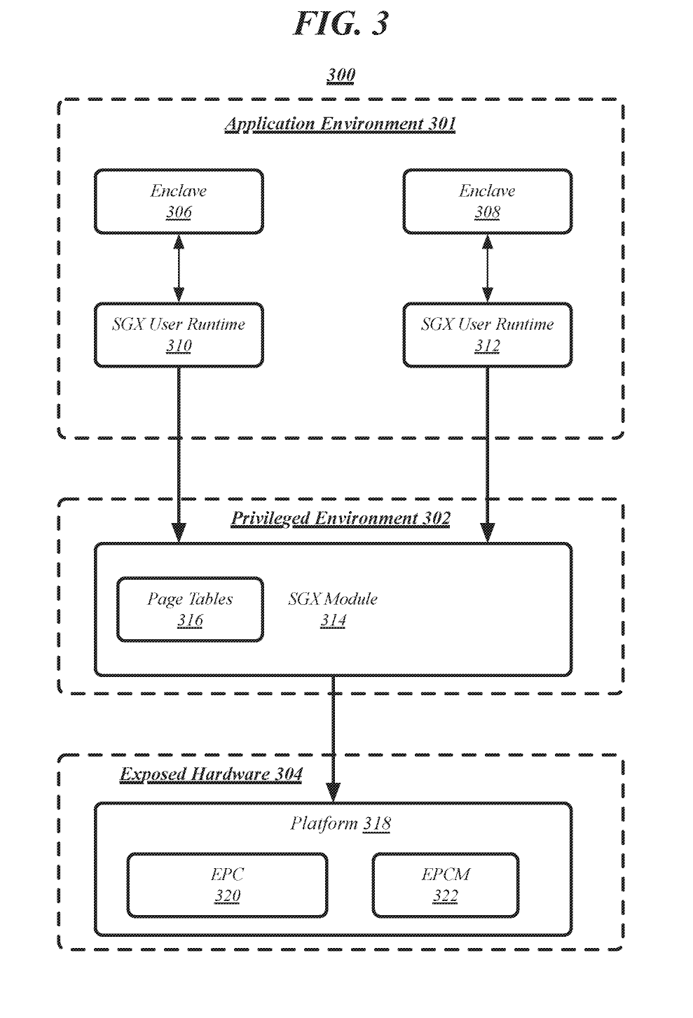

FIG. 3 illustrates an architecture of a trusted enclave system 300. Trusted enclave system 300 may include an application environment 301, privileged environment 302, and exposed hardware 304, each discussed in turn now. Application environment 301 may include one or more enclaves, 306, 308, each accessed using one or more SGX user runtime modules 310, 312. In this manner, each enclave 306, 308, may be accessed in a secure manner by privileged environment 302. Privileged environment 302 may include an SGX module 314, and pages tables 314. SGX module 314 may include a combination of software and hardware, and may be configured to request secret information, or perform trusted functions on secret information, from an enclave 306, 308 via SGX user runtimes 310, 312. Page tables 316 may store one or more memory locations for secret data stored within exposed hardware 304, for example. Exposed hardware 304 may include a computing platform 318, as described herein, and may include one or more processors configured to perform the techniques set forth within.

Platform 318 may include a storage device storing enclave page cache (EPC) 320 and enclave page cache map (EPCM) 322. EPC 320 may be a memory that includes a structure EPCM 322 for associating a set of access permissions with an enclave. EPC 320 may contain protected code and data in pages, which in some embodiments may be 4 KB pages in a non-limiting example. EPC 320 may store enclave pages and SGX structures, and EPC pages may be valid or invalid. A valid EPC page may contain either an enclave page or an SGX structure. The security attributes for each EPC page may be held in an internal micro-architecture structure called EPCM, discussed below.

EPCM 322 may contain metadata of enclave pages and may be a protected structure used by a processor to track the contents of EPC 320. EPCM 322 may be comprised of a series of entries with exactly one entry for each page in EPC 320. It can be appreciated that alternate embodiments may not require a 1:1 correlation. EPCM 322 may be managed by the processor as part of various SGX instructions and may not be directly accessible to software or to devices. The format of EPCM 322 may be microarchitectural and is implementation dependent. However, logically, each EPCM entry may hold one or more of the following: whether the EPC page is valid or invalid; the enclave instance that owns the page; the type of page (REG, TCS, VA, SECS); the virtual address through which the enclave can access the page; the enclave specified read/write/execute permissions on that page; and/or whether the page is accessible or not (BLOCKED or UNBLOCKED). The EPCM structure may be used by the processor in the address translation flow to enforce access-control on the enclave pages loaded into the EPC. Logically it may provide an additional secure layer of access control in addition to “legacy” segmentation, paging tables, and extended paging tables mechanisms.

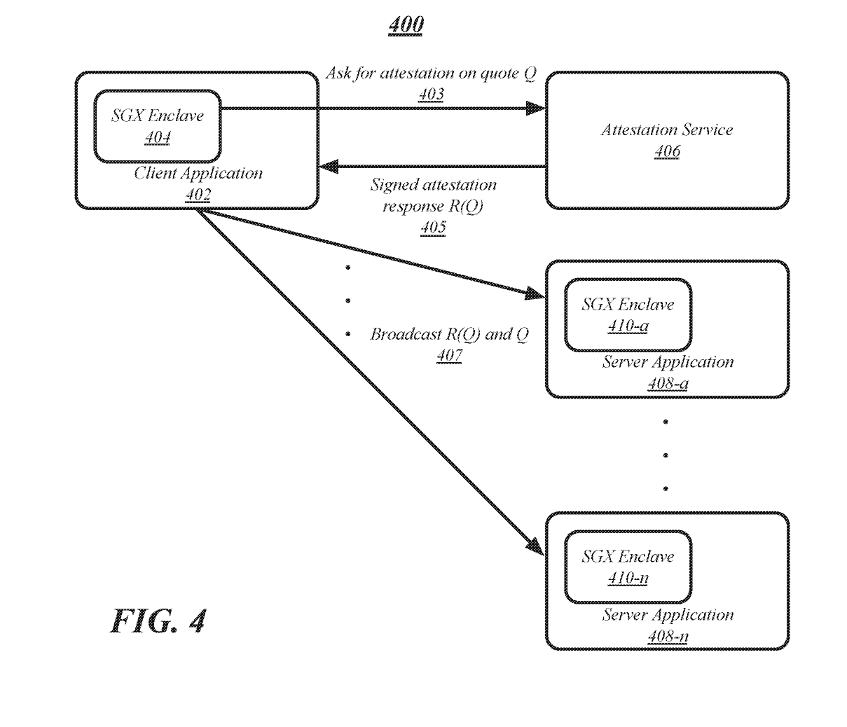

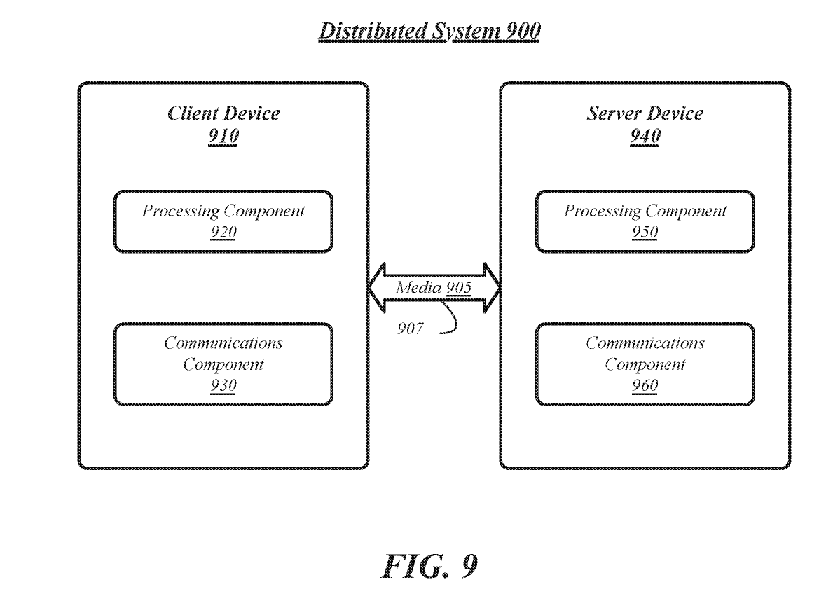

FIG. 4 illustrates a block diagram for a system 400. In one embodiment, the system 400 may comprise one or more components. Although the system 400 shown in FIG. 4 has a limited number of elements in a certain topology, it may be appreciated that the system 400 may include more or less elements in alternate topologies as desired for a given implementation. The system 400 may include a plurality of modules, which may each include one or more processing units, storage units, network interfaces, or other hardware and software elements described in more detail herein. In some embodiments, these modules may be included within a single device. In other embodiments, one or more modules may be part of a distributed architecture, an example of which is described with respect to FIG. 9.

In an embodiment, each module of system 400 may comprise without limitation, a mobile computing device, a smart phone, a cellular telephone, a device connected to the Internet of Things (IoT), a handset, a personal digital assistant, a one-way pager, a two-way pager, a messaging device, a computer, a personal computer (PC), a desktop computer, a laptop computer, a notebook computer, a handheld computer, a tablet computer, or a wearable computing device such as a smart watch. Further, modules may include a server, which may comprise without limitation a single server, a server array or server farm, a web server, a network server, an Internet server, a work station, a mini-computer, a mainframe computer, a supercomputer, a network appliance, a web appliance, multiprocessor systems, processor-based systems, or any combination thereof.

In various embodiments, system 400 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within system 400, and components and/or modules within a device of system 400, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the various modules and storages of system 400 may be organized as a distributed system. A distributed system typically comprises multiple autonomous computers that communicate through a computer network. The computers may interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

System 400 may include SGX enclave 404. While enclave 404 may be illustrated as an SGX enclave, it can be appreciated that other types of enclaves may be used in some embodiments. In this example, enclave 404 may be part of an SGX, which may allow devices to execute sensitive portions of an application, such as client application 402, in a secure environment, called an enclave, to protect both code and data from compromise. In distributed applications, such as IoT systems, in one example, enclaves residing on different processors may be required to mutually authenticate to establish secure communication channels. Currently, many solutions that allow two remote SGX enclaves to authenticate one another rely upon a centralized trusted authority. Some solutions, like TLS authentication, may rely on the interaction with a centralized Certification Authority (CA) for distribution and verification of public-key certificates. The certificates in these instances may be issued to individuals or corporations and expose individual identity.

The system set forth within FIG. 4 may use the authentication provided by the Intel Attestation Server (IAS) for any SGX enclave without the need for a centralized trusted authority. It can be appreciated that other types of attestation servers may be used in various embodiments. In some embodiments, authentication may be based on the hardware enhanced privacy ID (EPID) rather than an identifier connected to an individual or application. In this manner, the privacy of the individual platform or its user may be preserved. Authentication, in some embodiments, may therefore be anonymous, proving that the enclave is running in valid SGX hardware while protecting the identity of the device and/or user. An enclave may then trust attestation by the remote enclave of the code that it is running. In this manner, techniques described herein may provide several advantages including, allowing for the protection of the identity of SGX devices and owners, since in some embodiments, a public-key certificate may be issued anonymously to an SGX enclave running on valid SGX hardware. Further, techniques described herein may require minimal modifications to SGX-based distributed applications that may need to be strengthened with authentication. Still further, as mentioned above, techniques described herein may provide authentication between enclaves without the need for a centralized authority.

As illustrated within FIG. 4, a client application 402, which may be running on a client device as described herein, may execute and/or store data using a secure enclave, such as SGX enclave 404. SGX enclave may reside on one or more processors of a client device in some embodiments. While specific examples are used throughout, the techniques described may be used with any processor within various types of trusted execution environments. As set forth above, while enclave 404 may be illustrated as an SGX enclave, other secure enclaves may be used in some embodiments. SGX enclave 404 may generate data that to be sent to other secure enclaves, such as SGX enclaves 410-a-n which may reside on one or more server devices, which may each respectively run one or more server applications 408-a-n, where a and n represent positive integers. Each of SGX enclaves 410-a-n may reside on different processors, and thus may be required to be authenticated to establish secure data communication channels with SGX enclave 104.

In an embodiment, an SGX enclave 404 may generate an SGX report containing a cryptographic hash of the data using any well-known cryptographic hashing algorithm, such as SHA-1 or SHA-256, for example. Client application 402 may generate a linkable quote on the SGX report, which may be signed by a Quoting Enclave (QE) (not shown) which may, in turn, generate a quote that contains the report and the cryptographic hash. In some embodiments, a quoting enclave may be included within a device as a separate component from an SGX enclave, and may be configured to generate quotes as set forth herein. At 403, SGX enclave 404 may request for attestation of the quote Q from attestation service 406, IAS in some examples, which may reside on a remote server. The attestation response 405 from attestation service 406 may be signed with a public IAS Report Key and may contain a copy of the quote, as illustrated.

Client application 402 may, at 407, send the quote, the IAS attestation report on said quote and the data, to one or more other enclaves residing on different processors, such as SGX enclaves 410-a-n. These enclaves may verify the validity of the quote by checking the signature on the IAS response with the IAS Report Key. The recipient enclave may verify that the cryptographic hash of the data corresponds to the hash within the quote. In this manner, the data may be trusted to come directly from the sending enclave.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

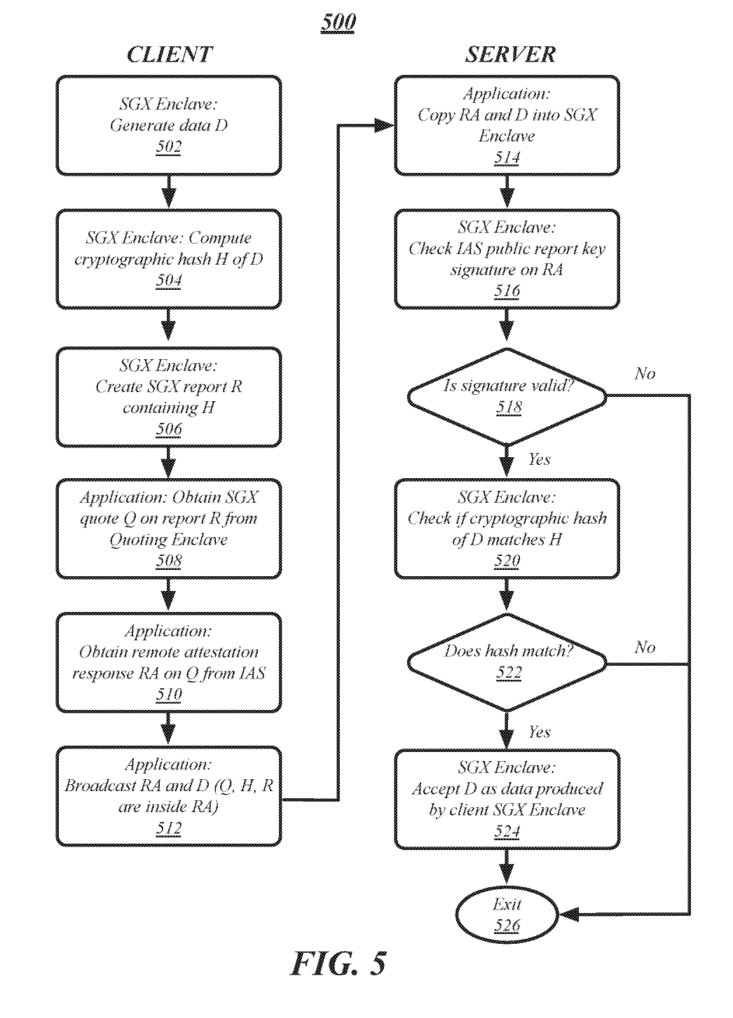

FIG. 5 illustrates a logic flow 500 according to an embodiment. First, on a client side, at 502, SGX enclave may generate data D, which may include any data that an application may require to be securely handled by a secure enclave. At 504, SGX enclave may compute a cryptographic hash H of D using a well-known hash algorithm, such as SHA-1 or SHA-256, for example. At 506, SGX enclave may create a SGX report R containing H. At 508, the application may obtain the SGX quote Q on report R from a quoting enclave, which as described above, may comprise a separate enclave component configured to generate the quote. At 510, the application may obtain a remote attestation response RA on Q from IAS, which is used in exemplary embodiments, however, other remote attestation services may be used. At 512, an application may broadcast RA and D (Q, H, R are inside RA) to one or more server components, each including a server application and enclave, as illustrated above with respect to FIG. 4.

Turning to the server side, at 514, an application on the server-side may copy RA and D into a server SGX enclave associated with the server-side application. In some embodiments, the server-side application may be associated with a secure enclave that is different than a processor associated with a client application that generated D initially. At 516, the server SGX enclave may check the included IAS public report key signature on RA. At 518, the validity of the signature may be checked for validity and, if not valid, the logic flow may exit at 526. If valid, at 520, the server SGX enclave may check if the cryptographic hash of D matches H. If no match, the logic flow may exit at 526. If a match is found, at 524, the SGX enclave may accept D as data produced by a client SGX enclave.

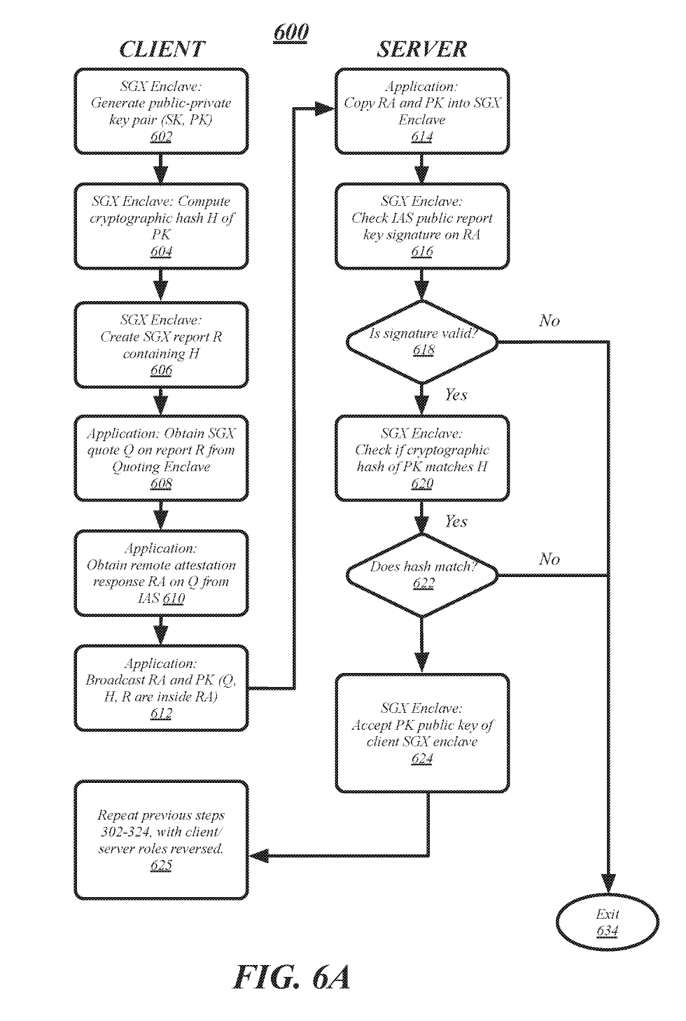

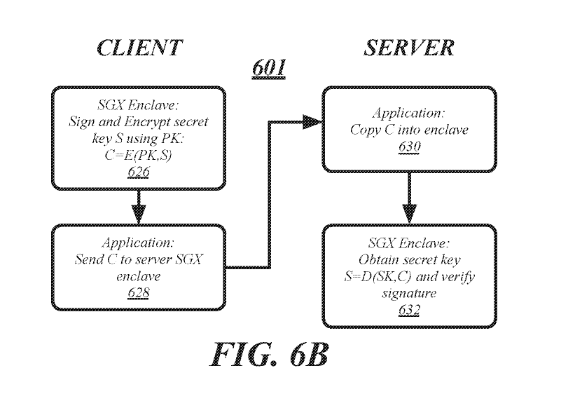

FIG. 6A illustrates a logic flow 600 according to an embodiment. As illustrated within FIG. 6A, remote enclave authentication may be performed where the data exchanged is a public key. In this situation, the attestation server (IAS) may guarantee that such a public key was generated by a legitimate SGX enclave. In other words, the IAS may act as a notary system attesting that a particular SGX enclave (having the attributes specified in the quote) has issued a public key. The IAS may assume a similar role as a CA in the TLS realm, for example. In some embodiments, the public key may be used to authenticate data originated by enclave that issued it (e.g. as symmetric key to establish a secure channel). As described below with respect to FIG. 6B, two remote enclaves (run by a client application and a server application, similar to that illustrated within FIG. 4) may need to securely exchange a symmetric session key S, for example.

Starting on the client side, at 602, an SGX enclave may generate a public-private key pair (SK, PK) using known public-private key cryptography techniques. At 604, the SGX enclave may compute a cryptographic hash H of PK, using known cryptographic hash techniques, such as SHA-1 or SHA-256, for example. At 606, the SGX enclave may create an SGX report R containing hash H. At 608, a client application may obtain an SGX quote Q on report R from a quote enclave, which as described above, may be included as a separate component within a client device that also contains SGX enclave. At 610, the client application may obtain remote attestation response RA on Q from IAS, for example, or using other attestation services in other embodiments. At 612, an application may broadcast RA and PK (Q, H, R may be included in RA) to one or more server applications residing on one or more respective servers, which each include a respective secure enclave, such as a SGX enclave.

Turning to the server side, at 614, an application may copy RA and PK into a server-side SGX enclave. At 616, the server-side SGX enclave may check the IAS public report key signature on RA. At 618, if the signature is not valid the logic flow may exit at 634. If valid, at 620, the server-side SGX enclave may check if a cryptographic hash of PK matches H. If no match at 622, the logic flow may exit at 634. If a match is made, at 624, the server-side SGX enclave may accept the public key of the client-side SGX enclave. In turn, at 625, the server-side SGX enclave may send its public key to the client-side SGX enclave in a similar manner described above with respect to steps 602-624, and the process may repeat with the roles of server and client reversed, in which the steps 602-622 may be repeated utilizing the public key of the server-side SGX enclave. In this manner, secrets may be sent back and forth between the client and server SGX enclaves, as set forth below with respect to FIG. 6B.

In some embodiments, it can be appreciated that, in addition to what is described above, linkable quotes may be used to obtain a unique identifier for a processor running an SGX enclave. This identifier may be the unique EPID pseudonym contained in the IAS response, for example. This feature may be used to limit the number of issued public keys to one per SGX processor for applications that need this constraint. This constraint may come at the cost of sacrificing the anonymity provided by EPID. Since each SGX platform is now identified by the EPID pseudonym, anonymity may be reduced to ‘pseudonymity’ in this embodiment.

FIG. 6B illustrates a logic flow 601 according to an embodiment. At 626, the client-side SGX enclave may sign and encrypt a secret key S using PK: C=E=PK, S). At 628, the application may send C to the server-side SGX enclave. Turning to the server side, at 630, the application may copy C into the server-side SGX enclave. At 632, the server-side SGX enclave may obtain a secret key S=D(SK, C) and verify the signature of the client-side SGX enclave. It can be appreciated that the logic flow of FIG. 6B may be performed in the opposite direction, i.e., from server-side SGX enclave to client-side SGX enclave, in some embodiments.

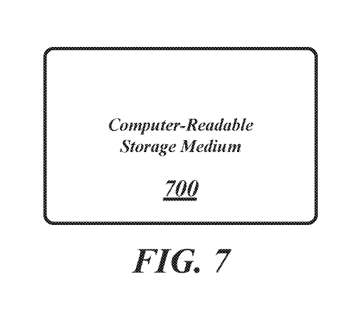

FIG. 7 illustrates an article of manufacture according to an embodiment. Storage medium 700 may comprise any computer-readable storage medium or machine-readable storage medium, such as an optical, magnetic or semiconductor storage medium. In some embodiments, storage medium 700 may comprise a non-transitory storage medium. In various embodiments, storage medium 700 may comprise an article of manufacture. In some embodiments, storage medium 700 may store computer-executable instructions, such as computer-executable instructions to implement logic flows 500, 600, and/or 601, for example. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited to these examples.

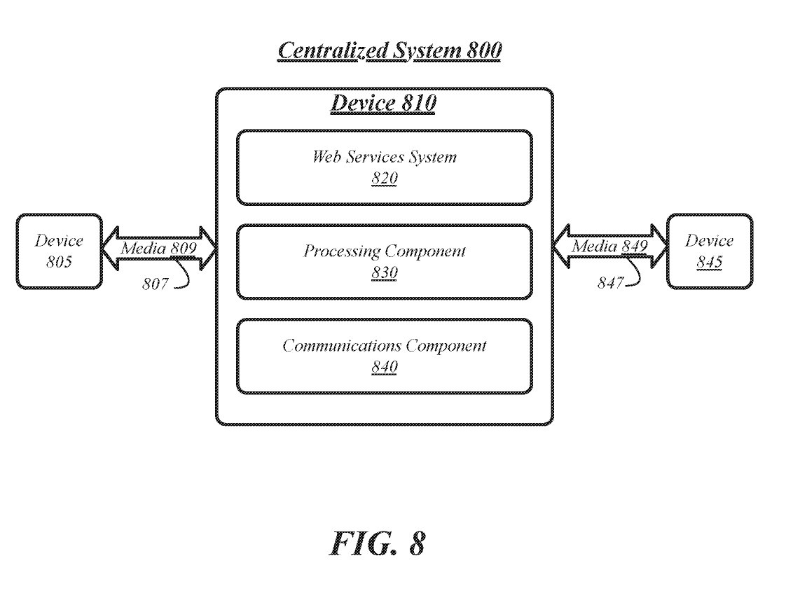

FIG. 8 illustrates a block diagram of a centralized system 800. The centralized system 800 may implement some or all of the structure and/or operations for the web services system 820 in a single computing entity, such as entirely within a single device 810.

The device 810 may comprise any electronic device capable of receiving, processing, and sending information for the web services system 820. Examples of an electronic device may include without limitation a client device, a personal digital assistant (PDA), a mobile computing device, a smart phone, a cellular telephone, ebook readers, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a network appliance, a web appliance, a distributed computing system, multiprocessor systems, processor-based systems, consumer electronics, programmable consumer electronics, game devices, television, set top box, wireless access point, base station, subscriber station, mobile subscriber center, radio network controller, router, hub, gateway, bridge, switch, machine, or combination thereof. The embodiments are not limited in this context.

The device 810 may execute processing operations or logic for the web services system 820 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 810 may execute communications operations or logic for the web services system 820 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 809, 849 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 810 may communicate with other devices 805, 845 over a communications media 809, 849, respectively, using communications signals 807, 847, respectively, via the communications component 840. The devices 805, 845, may be internal or external to the device 810 as desired for a given implementation.

For example, device 805 may correspond to a client device such as a phone used by a user. Signals 807 sent over media 809 may therefore comprise communication between the phone and the web services system 820 in which the phone transmits a request and receives a web page or other data in response.

Device 845 may correspond to a second user device used by a different user from the first user, described above. In one embodiment, device 845 may submit information to the web services system 820 using signals 847 sent over media 849 to construct an invitation to the first user to join the services offered by web services system 820. For example, if web services system 820 comprises a social networking service, the information sent as signals 847 may include a name and contact information for the first user, the contact information including phone number or other information used later by the web services system 820 to recognize an incoming request from the user. In other embodiments, device 845 may correspond to a device used by a different user that is a friend of the first user on a social networking service, the signals 847 including status information, news, images, contact information, or other social-networking information that is eventually transmitted to device 805 for viewing by the first user as part of the social networking functionality of the web services system 820.

FIG. 9 illustrates a block diagram of a distributed system 900. The distributed system 900 may distribute portions of the structure and/or operations for the disclosed embodiments across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 940. In general, the client device 910 and the server device 940 may be the same or similar to the client device 810 as described with reference to FIG. 8. For instance, the client system 910 and the server system 940 may each comprise a processing component 920, 950 and a communications component 930, 960 which are the same or similar to the processing component 830 and the communications component 840, respectively, as described with reference to FIG. 8. In another example, the devices 910, 940 may communicate over a communications media 605 using communications signals 907 via the communications components 930, 960.

The client device 910 may comprise or employ one or more client programs that operate to perform various methodologies in accordance with the described embodiments. In one embodiment, for example, the client device 910 may implement some steps described with respect to FIGS. 5 and 6A-B.

The server device 940 may comprise or employ one or more server programs that operate to perform various methodologies in accordance with the described embodiments. In one embodiment, for example, the server device 940 may implement some steps described with respect to FIGS. 5 and 6A-B.

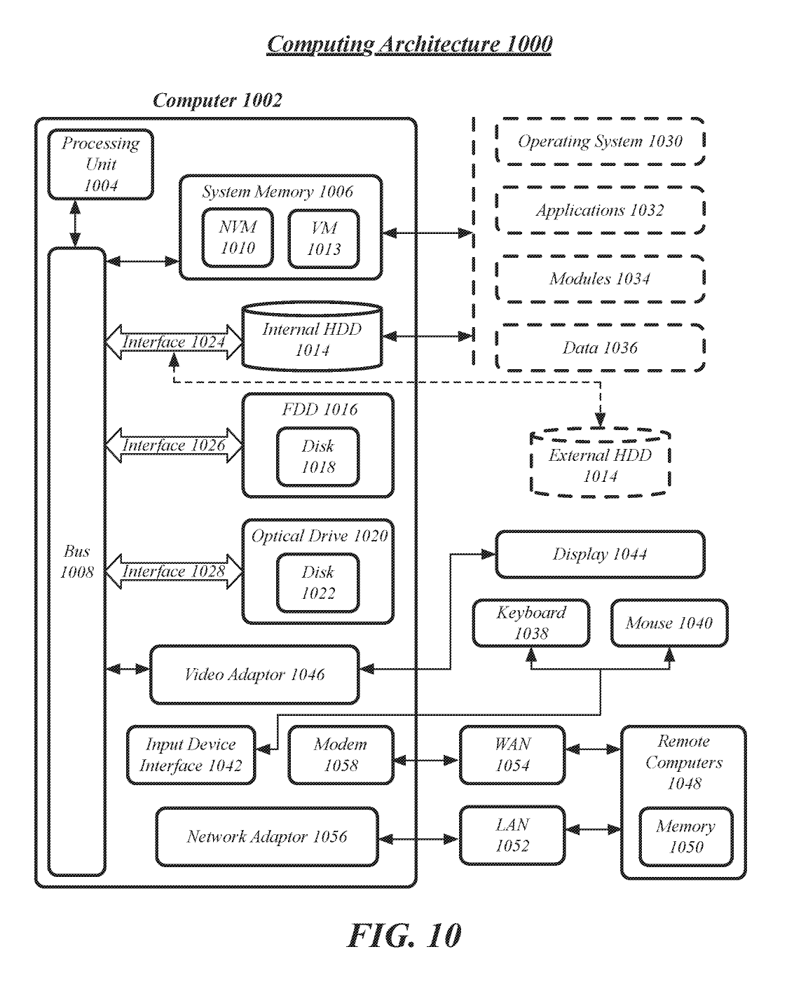

FIG. 10 illustrates an embodiment of an exemplary computing architecture 700 suitable for implementing various embodiments as previously described. In one embodiment, the computing architecture 1000 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1013. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM, DVD, or Blu-ray). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1013, including an operating system 1030, one or more application programs 1032, other program modules 1034, and program data 1036. In one embodiment, the one or more application programs 1032, other program modules 1034, and program data 1036 can include, for example, the various applications and/or components to implement the disclosed embodiments.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A display 1044 is also connected to the system bus 1008 via an interface, such as a video adaptor 1046. The display 1044 may be internal or external to the computer 1002. In addition to the display 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

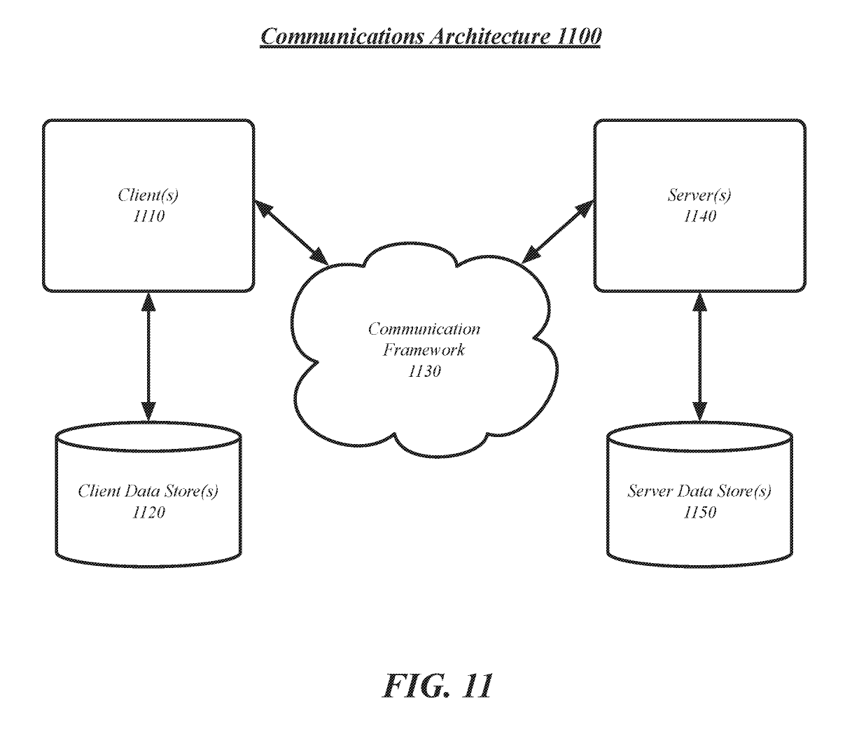

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1110 and servers 1140. The clients 1110 may implement the client device 1110, for example. The servers 1140 may implement the server device 1140, for example. The clients 1110 and the servers 1140 are operatively connected to one or more respective client data stores 1120 and server data stores 1150 that can be employed to store information local to the respective clients 1110 and servers 1140, such as cookies and/or associated contextual information.

The clients 1110 and the servers 1140 may communicate information between each other using a communication framework 1130. The communications framework 1130 may implement any well-known communications techniques and protocols. The communications framework 1130 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1130 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1110 and the servers 1140. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

### Example 1

A system for enclave authentication, comprising: a client-side secure enclave, executed by a processor, and configured to: generate a public-private key pair (SK, PK); compute a cryptographic hash H of PK; create a report R containing H; obtain a quote Q on the report R from a quoting enclave component; obtain remote attestation response RA from an attestation service; and broadcast RA and PK to one or more server-side enclaves.

### Example 2

The system of Example 1, wherein the cryptographic hash is performed using SHA-1 or SHA-256 hash algorithms.

### Example 3

The system of Example 1, wherein the secure enclaves are Software Guard Extensions (SGX) enclaves.

### Example 4

The system Example 1, wherein the report is a Software Guard Extensions (SGX) report.

### Example 5

The system of Example 1, wherein the quote is a Software Guard Extensions (SGX) quote.

### Example 6

The system of Example 1, wherein the attestation service is an Intel Attestation Service (IAS).

### Example 7

A computer-implemented method for enclave authentication at a client-side secure enclave, comprising: generating a public-private key pair (SK, PK); computing a cryptographic hash H of PK; creating a report R containing H; obtaining a quote Q on the report R from a quoting enclave component; obtaining remote attestation response RA from an attestation service; and broadcasting RA and PK to one or more server-side enclaves.

### Example 8

The computer-implemented method of Example 7, wherein the cryptographic hash is performed using SHA-1 or SHA-256 hash algorithms.

### Example 9

The computer-implemented method of Example 7, wherein the secure enclaves are Software Guard Extensions (SGX) enclaves.

### Example 10

The computer-implemented method of Example 7, wherein the report is a Software Guard Extensions (SGX) report.

### Example 11

The computer-implemented method of Example 7, wherein the quote is a Software Guard Extensions (SGX) quote.

### Example 12

The computer-implemented method of Example 7, wherein the attestation service is an Intel Attestation Service (IAS).

### Example 13

An article comprising a non-transitory computer-readable storage medium that stores instructions for execution by processing circuitry of a computing device for enclave authentication at a client-side secure enclave, the instructions to cause the computing device to: generate a public-private key pair (SK, PK); compute a cryptographic hash H of PK; create a report R containing H; obtain a quote Q on the report R from a quoting enclave component; obtain remote attestation response RA from an attestation service; and broadcast RA and PK to one or more server-side enclaves.

### Example 14

The article of Example 13, wherein the cryptographic hash is performed using SHA-1 or SHA-256 hash algorithms.

### Example 15

The article of Example 13, wherein the secure enclaves are Software Guard Extensions (SGX) enclaves.

### Example 16

The article of Example 13, wherein the report is a Software Guard Extensions (SGX) report.

### Example 17

The article of Example 13, wherein the quote is a Software Guard Extensions (SGX) quote.

### Example 18

The article of Example 13, wherein the attestation service is an Intel Attestation Service (IAS).

### Example 19

A computing device for enclave authentication at a client-side secure enclave, comprising: means for generating a public-private key pair (SK, PK); means for computing a cryptographic hash H of PK; means for creating a report R containing H; means for obtaining a quote Q on the report R from a quoting enclave component; means for obtaining remote attestation response RA from an attestation service; and means for broadcasting RA and PK to one or more server-side enclaves.

### Example 20

The computing device of Example 19, wherein the cryptographic hash is performed using SHA-1 or SHA-256 hash algorithms.

### Example 21

The computing device of Example 19, wherein the secure enclaves are Software Guard Extensions (SGX) enclaves.

### Example 22

The computing device of Example 19, wherein the report is a Software Guard Extensions (SGX) report.

### Example 23

The computing device of Example 19, wherein the quote is a Software Guard Extensions (SGX) quote.

### Example 24

The computing device of Example 19, wherein the attestation service is an Intel Attestation Service (IAS).

### Example 25

An apparatus for enclave authentication at a client-side secure enclave, comprising: at least one memory; at least one processor; and logic, at least a portion of the logic comprised in hardware and executed by the at least one processor, the logic to: generate a public-private key pair (SK, PK); compute a cryptographic hash H of PK; create a report R containing H; obtain a quote Q on the report R from a quoting enclave component; obtain remote attestation response RA from an attestation service; and broadcast RA and PK to one or more server-side enclaves.

### Example 26

The apparatus of Example 25, wherein the cryptographic hash is performed using SHA-1 or SHA-256 hash algorithms.

### Example 27

The apparatus of Example 25, wherein the secure enclaves are Software Guard Extensions (SGX) enclaves.

### Example 28

The apparatus of Example 25, wherein the report is a Software Guard Extensions (SGX) report.

### Example 29

The apparatus of Example 25, wherein the quote is a Software Guard Extensions (SGX) quote.

### Example 30

The apparatus of Example 25, wherein the attestation service is an Intel Attestation Service (IAS).

### Example 31

A system for enclave authentication, comprising: a server-side secure enclave, executed by a processor, and configured to: receive a remote attestation response RA including a quote Q, hash H of a public-private key pair (SK, PK), and report R; receive public key PK; store RA and PK into the server-side secure enclave;

determine that an attestation service public report key signature on RA is valid;

determine that a cryptographic hash of PK matches H; and accept PK as an authenticated public key of a client-side secure enclave.

### Example 32

The system of Example 31, wherein the cryptographic hash is performed using SHA-1 or SHA-256 hash algorithms.

### Example 33

The system of Example 31, wherein the secure enclaves are a Software Guard Extensions (SGX) enclaves.

### Example 34

The system Example 31, wherein the report is a Software Guard Extensions (SGX) report.

### Example 35

The system of Example 31, wherein the quote is a Software Guard Extensions (SGX) quote.

### Example 36

The system of Example 31, wherein the attestation service is an Intel Attestation Service (IAS).

### Example 37

A computer-implemented method for enclave authentication, comprising: receiving, at a server-side secure enclave, a remote attestation response RA including a quote Q, hash H of a public-private key pair (SK, PK), and report R; receiving, at the server-side secure enclave, public key PK; storing RA and PK into the server-side secure enclave; determining that an attestation service public report key signature on RA is valid; determining that a cryptographic hash of PK matches H; and accepting PK as an authenticated public key of a client-side secure enclave.

### Example 38

The computer-implemented method of Example 37, wherein the cryptographic hash is performed using SHA-1 or SHA-256 hash algorithms.

### Example 39

The computer-implemented method of Example 37, wherein the secure enclaves are a Software Guard Extensions (SGX) enclaves.

### Example 40

The computer-implemented method of Example 37, wherein the report is a Software Guard Extensions (SGX) report.

### Example 41

The computer-implemented method of Example 37, wherein the quote is a Software Guard Extensions (SGX) quote.

### Example 42

The computer-implemented method of Example 37, wherein the attestation service is an Intel Attestation Service (IAS).

### Example 43

An article comprising a non-transitory computer-readable storage medium that stores instructions for execution by processing circuitry of a computing device for enclave authentication, the instructions to cause the computing device to: receive, at a server-side secure enclave, a remote attestation response RA including a quote Q, hash H of a public-private key pair (SK, PK), and report R; receive, at the server-side secure enclave, public key PK; store RA and PK into the server-side secure enclave; determine that an attestation service public report key signature on RA is valid; determine that a cryptographic hash of PK matches H; and accept PK as an authenticated public key of a client-side secure enclave.

### Example 44

The article of Example 43, wherein the cryptographic hash is performed using SHA-1 or SHA-256 hash algorithms.

### Example 45

The article of Example 43, wherein the secure enclaves are a Software Guard Extensions (SGX) enclaves.

### Example 46

The article of Example 43, wherein the report is a Software Guard Extensions (SGX) report.

### Example 47

The article of Example 43, wherein the quote is a Software Guard Extensions (SGX) quote.

### Example 48

The article of Example 43, wherein the attestation service is an Intel Attestation Service (IAS).

### Example 49

A computing device for enclave authentication, comprising: means for receiving, at a server-side secure enclave, a remote attestation response RA including a quote Q, hash H of a public-private key pair (SK, PK), and report R; means for receiving, at the server-side secure enclave, public key PK; means for storing RA and PK into the server-side secure enclave; means for determining that an attestation service public report key signature on RA is valid; means for determining that a cryptographic hash of PK matches H; and means for accepting PK as an authenticated public key of a client-side secure enclave.

### Example 50

The computing device of Example 49, wherein the cryptographic hash is performed using SHA-1 or SHA-256 hash algorithms.

### Example 51

The computing device of Example 49, wherein the secure enclaves are a Software Guard Extensions (SGX) enclaves.

### Example 52

The computing device of Example 49, wherein the report is a Software Guard Extensions (SGX) report.

### Example 53

The computing device of Example 49, wherein the quote is a Software Guard Extensions (SGX) quote.

### Example 54

The computing device of Example 49, wherein the attestation service is an Intel Attestation Service (IAS).

### Example 55

An apparatus for enclave authentication, comprising: at least one memory; at least one processor; and logic, at least a portion of the logic comprised in hardware and executed by the at least one processor, the logic to: receive a remote attestation response RA including a quote Q, hash H of a public-private key pair (SK, PK), and report R; receive a public key PK; store RA and PK into the server-side secure enclave; determine that an attestation service public report key signature on RA is valid; determine that a cryptographic hash of PK matches H; and accept PK as an authenticated public key of a client-side secure enclave.

### Example 56

The apparatus of Example 55, wherein the cryptographic hash is performed using SHA-1 or SHA-256 hash algorithms.

### Example 57

The apparatus of Example 55, wherein the secure enclaves are a Software Guard Extensions (SGX) enclaves.

### Example 58

The apparatus of Example 55, wherein the report is a Software Guard Extensions (SGX) report.

### Example 59

The apparatus of Example 55, wherein the quote is a Software Guard Extensions (SGX) quote.

### Example 60

The apparatus of Example 55, wherein the attestation service is an Intel Attestation Service (IAS).

1. A system for enclave authentication, comprising:
a client-side secure enclave, executed by a processor, and configured to:
generate a public-private key pair (SK, PK);
compute a cryptographic hash H of PK;
create a report R containing H;
obtain a quote Q on the report R from a quoting enclave component;
obtain remote attestation response RA from an attestation service; and
broadcast RA and PK to one or more server-side enclaves.

2. The system of claim 1, wherein the cryptographic hash is performed using SHA-1 or SHA-256 hash algorithms.

3. The system of claim 1, wherein the secure enclaves are Software Guard Extensions (SGX) enclaves.

4. The system claim 1, wherein the report is a Software Guard Extensions (SGX) report.

5. The system of claim 1, wherein the quote is a Software Guard Extensions (SGX) quote.

6. The system of claim 1, wherein the attestation service is an Intel Attestation Service (IAS).

7. A computer-implemented method for enclave authentication at a client-side secure enclave, comprising:
generating a public-private key pair (SK, PK);
computing a cryptographic hash H of PK;
creating a report R containing H;
obtaining a quote Q on the report R from a quoting enclave component;
obtaining remote attestation response RA from an attestation service; and
broadcasting RA and PK to one or more server-side enclaves.

8. The computer-implemented method of claim 7, wherein the cryptographic hash is performed using SHA-1 or SHA-256 hash algorithms.

9. The computer-implemented method of claim 7, wherein the secure enclaves are Software Guard Extensions (SGX) enclaves.

10. The computer-implemented method of claim 7, wherein the report is a Software Guard Extensions (SGX) report.

11. The computer-implemented method of claim 7, wherein the quote is a Software Guard Extensions (SGX) quote.

12. The computer-implemented method of claim 7, wherein the attestation service is an Intel Attestation Service (IAS).

13. An article comprising a non-transitory computer-readable storage medium that stores instructions for execution by processing circuitry of a computing device for enclave authentication at a client-side secure enclave, the instructions to cause the computing device to:
generate a public-private key pair (SK, PK);
compute a cryptographic hash H of PK;
create a report R containing H;
obtain a quote Q on the report R from a quoting enclave component;
obtain remote attestation response RA from an attestation service; and
broadcast RA and PK to one or more server-side enclaves.

14. A system for enclave authentication, comprising:
a server-side secure enclave, executed by a processor, and configured to:
receive a remote attestation response RA including a quote Q, hash H of a public-private key pair (SK, PK), and report R;
receive public key PK;
store RA and PK into the server-side secure enclave;
determine that an attestation service public report key signature on RA is valid;
determine that a cryptographic hash of PK matches H; and
accept PK as an authenticated public key of a client-side secure enclave.

15. The system of claim 14, wherein the cryptographic hash is performed using SHA-1 or SHA-256 hash algorithms.

16. The system of claim 14, wherein the secure enclaves are a Software Guard Extensions (SGX) enclaves.

17. The system claim 14, wherein the report is a Software Guard Extensions (SGX) report.

18. The system of claim 14, wherein the quote is a Software Guard Extensions (SGX) quote.

19. The system of claim 14, wherein the attestation service is an Intel Attestation Service (IAS).

20. A computer-implemented method for enclave authentication, comprising:
receiving, at a server-side secure enclave, a remote attestation response RA including a quote Q, hash H of a public-private key pair (SK, PK), and report R;
receiving, at the server-side secure enclave, public key PK;
storing RA and PK into the server-side secure enclave;
determining that an attestation service public report key signature on RA is valid;
determining that a cryptographic hash of PK matches H; and
accepting PK as an authenticated public key of a client-side secure enclave.

21. The computer-implemented method of claim 20, wherein the cryptographic hash is performed using SHA-1 or SHA-256 hash algorithms.

22. The computer-implemented method of claim 20, wherein the secure enclaves are a Software Guard Extensions (SGX) enclaves.

23. The computer-implemented method of claim 20, wherein the report is a Software Guard Extensions (SGX) report.

24. The computer-implemented method of claim 20, wherein the quote is a Software Guard Extensions (SGX) quote.

25. The computer-implemented method of claim 20, wherein the attestation service is an Intel Attestation Service (IAS).
